(19) United States
(12) Patent Application Publication
(10) Pub. No.: US 2014/0167322 A1
(43) Pub. Date: Jun. 19, 2014

(54) SYSTEM AND METHOD FOR MOLDING ELASTOMER PARTS USING A TEMPERATURE-ACTIVATED PRESSURE APPLICATOR

(71) Applicant: EASTERN TECHNICAL PRODUCTS LLC, New Providence, NJ (US)

(72) Inventor: Finley Benjamin Miller, New Providence, NJ (US)

(73) Assignee: EASTERN TECHNICAL PRODUCTS LLC, New Providence, NJ (US)

(21) Appl. No.: 14/103,213

(22) Filed: Dec. 11, 2013

Related U.S. Application Data
(60) Provisional application No. 61/797,669, filed on Dec. 13, 2012.

(51) Int. Cl. B29C 51/42; B29C 37/00; B32B 1/08

(52) U.S. Cl. CPC B29C 51/42; B32B 1/08; B29C 37/0075
USPC 264/325; 428/36.4; 425/383

(57) ABSTRACT

This invention provides a method and system for manufacturing rubber parts that utilize a high temperature and high pressure molding process. In this method and system, uncured rubber in sheet form is contained within a metallic or other type of rigid mold cavity along with a pressure applicator which expands due to the heating and pressurizes the mold cavity. The pressure applicator may be made from silicone rubber, or other types of rubber exhibiting high coefficient of thermal expansion, and resistance to high temperatures. The assembly of the uncured rubber sheet, the pressure applicator, and the mold is heated to a specified temperature, and the thermal expansion of the pressure applicator consolidates the rubber sheet into the desired form as the rubber cures.

### CROSS-REFERENCE TO RELATED APPLICATION

This application claims priority to U.S. Provisional Application No. 61/797,669 filed Dec. 13, 2012. The entire disclosure of the above-referenced application is incorporated herein by reference in its entirety.

### TECHNICAL FIELD

The present disclosure relates to methods and systems for molding elastomers utilizing temperature-activated pressure applicators inside the mold.

### BACKGROUND

### Use of Trapped Silicone in Composite Fabrication

Application of pressure through the heating of a polymer with a high coefficient of thermal expansion, typically silicone rubber, has been employed in the past to fabricate composite structural components consisting of a thermosetting resin matrix and a structural fiber. The advantage of this method is that high pressures can be attained in the mold without the necessity of employing an expensive autoclave. Aerospace composite structures typically employ material systems that require elevated pressure and temperature during the cure cycle. A typical cure may call for 350° F. and 80 PSI.

Problems with Trapped Silicone

Despite extensive experimentation, temperature-activated pressure applicators have not become widely used in composite structure fabrication because of several difficulties with the process. The material systems that require high pressure and temperature are typically for aerospace or other very high value applications that also require stringent quality control. Because it is very difficult to accurately know the pressure of the mold during the cure process, and because this pressure cannot easily be controlled independently to the temperature of the mold, the use of this technique is generally impractical for the fabrication of composite structures.

One problem with temperature-activated pressure applicators is that very small changes in temperature can lead to large variations in pressure. The typical material used in this application is silicone rubber, which can have a bulk modulus of 9×10⁴ PSI or higher and a coefficient of thermal expansion of 4.6×10⁻⁶/° F. This can result in changes in pressure within the mold of as much as 200 PSI for a 10° F. change in the temperature of the mold assembly. Because of the high degree of sensitivity, the volume of materials in the mold, and the temperature of the various constituents, must be known with such a high degree of precision that the process of molding composite structures by this method is generally impractical. This difficulty is further exacerbated by the tendency of the silicone pressure applicators to shrink during the curing process. The pressure applicator not only shrinks during initial fabrication, but also with subsequent use. The shrinkage can be inconsistent and unpredictable. The combination of the necessity of very specifically controlling the volume and shape of the pressure applicator, and the tendency for the pressure applicator to contract makes it less practical as a molding technique. Weiser et al. (U.S. Pat. No. 5,814,259) sought to mitigate the extreme sensitivity of the process to changes in temperature by reducing the bulk modulus by adulterating the silicone used to fabricate the pressure applicator. They add fillers to the silicone and do not degas the silicone, both of which serve to reduce the bulk modulus. Barraclough (U.S. Pat. No. 4,624,820) sought to use hydraulic pressure to compensate for variations in the pressure during heat-up of the mold assembly. Both of these techniques are useful in certain applications.

Another problem with using temperature-activated pressure applicators in composite fabrication has been an inability to apply uniform pressure across the part during the molding process. It is difficult to prove that consistent and uniform pressure is being applied. Kemp (U.S. Pat. No. 4,889,668) uses selective heating and cooling of the pressure applicator to produce the desired amount of pressure, in an attempt to address this problem.

Despite repeated attempts to solve the various technical difficulties, temperature-activated pressure applicators continue to be used infrequently to fabricate composite structures due to the various deficiencies mentioned, and certain others. For example, reluctance to use silicone because of contamination concerns may also be a factor. Silicone, butyl, and fluoro-elastomers such as Viton have been used to fabricate flexible caul sheets and pressure concentrators for autoclave cured composite parts, but in these applications they are not being used to create the mold pressure, just to transmit it to the surface of the part.

Composite structures that can tolerate much wider variations in cure pressure and generally have less stringent quality control requirements would be a candidate for this type of molding, but the material systems used in these applications typically use low pressure/low temperature cure systems where the high pressure provided by the temperature-activated pressure applicators is not required. For this reason these types of structures also are not well suited to molding with temperature-activated pressure applicators.

Difficulties with Molding Certain Rubber Shapes

Certain types of rubbers are typically procured in uncured sheet form on a roll from the formulator. Fluoroelastomer, such as Viton, are an example of a rubber that fits this description. Typically, the rubber is molded under pressure and at elevated temperature to form it into the desired shape and cure it. Typically this may be done with a metal mold, where pressure is applied mechanically or hydraulically. For very large parts the pressure can be applied in an autoclave, but this is expensive. Molding these types of rubber into certain geometries, such as a long tubular rubber part with a constant or variable cross-section, may be difficult or impossible to mold using conventional molding processes.

### SUMMARY

In accordance with various embodiments, a molding system may comprise a mold tool that is operable to contain pressures generated during a molding process. The molding system may comprise a temperature-activated pressure applicator. The molding system may comprise an elastomer material positioned between the mold tool and the temperature-activated pressure applicator. The molding system may comprise a barrier positioned between the temperature-activated pressure applicator and the elastomer material. The barrier may be operable to reduce sticking to allow separation of the pressure applicator from the elastomer material after the molding process is complete.

In accordance with various embodiments, a method may be implemented for molding an elastomer material. A mold defining a mold cavity, a pressure applicator sized to substantially fill the mold cavity, a barrier disposed around the pressure applicator; and an uncured elastomer sheet disposed around the barrier may be provided. The barrier may be positioned between the elastomer sheet and the pressure applicator. Room sufficient to fit an elastomer sheet between the mold cavity and the pressure applicator may be provided. The pressure applicator, the elastomer sheet, and barrier may be inserted into the mold cavity. The cavity may be heated thereby causing the pressure applicator to expand and forcing the elastomer sheet into the shape of the mold cavity. The barrier may reduce sticking of the pressure applicator from the elastomer material after the molding process is complete. A molded elastomer part may be removed from the mold cavity and from the pressure applicator at the barrier.

In accordance with various embodiments, a molded elastomer part may include a tube formed of a fluoroelastomer material and fibers. The tube may include a layer of low-friction material lining the inside of the tube. The low-friction material may include at least one ply of fluorinated ethylene propylene. The tube may include at least one closed end.

### BRIEF DESCRIPTION OF THE DRAWINGS

FIG. 1 is a cross-section view of a tool for molding an elastomer with a temperature-activated, silicone core for applying outward pressure to the elastomer when heated; and

FIG. 2 is a flow-chart illustrating an exemplary method of producing a part utilizing the tool of FIG. 1 in accordance with various embodiments disclosed herein.

### DETAILED DESCRIPTION

This disclosure is related to methods and systems for molding elastomers (e.g., silicone, butyl, and fluoroelastomer such as Viton) utilizing temperature-activated pressure applicators inside the mold. Illustrative embodiments are described to provide an overall understanding of the disclosed apparatus and processes.

Temperature-activated pressure applicators may be used to mold rubber parts with certain advantages over conventional rubber molding techniques. Although it is difficult to control the local and overall pressure using this molding technique, as is well known, tolerances for rubber parts, for example bladders for vacuum molding of composite structures, may be much lower than for the composite structure applications that similar processes have been used for in the past. The process specifications detailing the process for curing composite structures established by the material vendors, or the manufacturers that use their products, may make it impractical to use temperature-activated pressure applicators, but certain rubber parts have lower tolerances and less strict molding process specifications, and using temperature-activated pressure applicators may be much more practical for these applications.

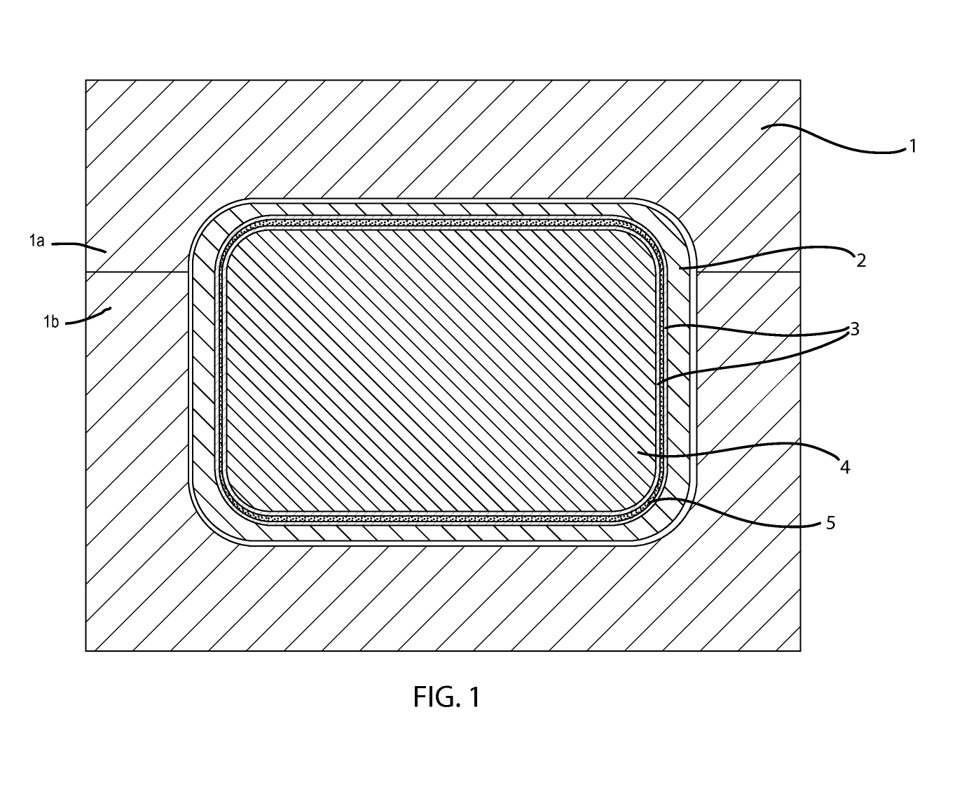

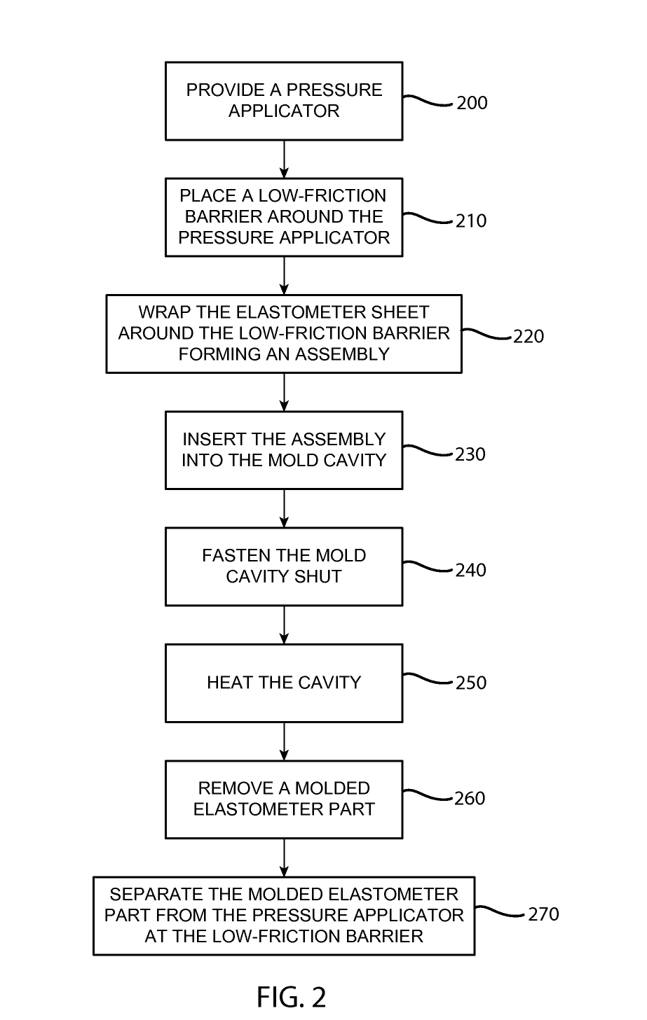

Tests were conducted where a tube made from uncured Viton rubber sheet was fabricated by casting a temperature-activated pressure applicator from liquid silicone rubber. As shown in FIG. 2 at step 200, the pressure applicator was sized so that it substantially filled the mold cavity, leaving room for the Viton rubber sheet, with, for example, approximately 5% of the mold volume being empty. Uncured Viton rubber sheet was wrapped around the pressure applicator, as shown in step 210, and inserted into a metallic mold that had been machined to the desired shape, as shown in step 230. The mold was bolted shut, as shown in step 240, and the assembly was heated to 320° F., as shown in step 250. The pressure applicator expanded as a result of the heating of the mold and exerted pressure on the Viton rubber, pushing it into the desired shape as it cured. FIG. 1 shows a cross-section schematic of the system after molding, where the pressure applicator (4) is separated from the molded part (2) by a low-friction barrier (3) which allows the pressure applicator to be removed after the molding is complete. The assembly is contained within a rigid metallic mold tool (1) which is designed to contain the pressure generated during the molding process. The mold tool (1) includes a first mold part (1a) and a second mold part (1b) that surround an interior cavity occupied by the pressure applicator, molded part, and/or barrier. The interior cavity defines the final shape of the elastomer material as it is pushed into the walls of the cavity.

After the mold had cooled, the part was demolded, as shown in step 260, and the pressure applicator was pulled away from the part. The process of removing the pressure applicator from the tube is quite easy if part of the pressure applicator is left to protrude from the end of the tube, so that it can be gripped by an operator and pulled out. Pulling on the applicator causes it to thin down and pull away from the walls of the tube, making it easy to pull out. Pushing it out of the tube is more difficult than pulling it because it tends to bunch. In certain instances, barrier plies (3) made from thin plastic may be used between the pressure applicator (4) and the part to reduce sticking, as shown in step 220. In some cases multiple barrier plies (3) made of 0.002 inch thick fluorinated ethylene propylene (FEP), which is a low-adhesion material may be used with a lubricant, such as talc powder (5), between the plies, to provide a low-friction surface, remove moisture (desiccant), and facilitate removal of the silicone pressure applicator, as shown in step 270. In some cases, a barrier may not be required to separate the pressure applicator from the molded part, and may be omitted from the process.

This process has been tested with tubes as long as 15 feet and for tubes with various cross-sectional geometries, FIG. 1 showing a polygonal example, and can be used with tubes that have inconsistent cross-sectional geometry, since the rubber applicator thins down as it is being pulled out, which prevents it from remaining trapped in the tube. Tubes were also made with a closed end molded into one end of the tube.

For certain applications, the precise molding pressure is not critical, as long as the pressure does not increase to the point where it damages the mold. The pressure can be controlled by sizing the pressure applicator appropriately, and also by monitoring the pressure and controlling it by adjusting the mold temperature. For instance, a part may be cured at 300° F. instead of 350° F. required for a full cure because the pressure was already approaching maximum acceptable levels when the mold assembly reached 300° F. After de-molding the partially cured part, the part can subsequently be fully cured (also known as post curing) at ambient pressure in an oven.

A method for molding rubber may include using an uncured rubber sheet, a fixed volume closed mold, and a pressure applicator made from a flexible polymer that expands as the mold assembly is heated and pressurizes the mold cavity. The rubber may be molded to form a part. The part may be tubular, and the pressure applicator may be contained within the tube as the part is cured, and subsequently removed from the tube after it is cured. The pressure applicator may be made from silicone rubber. The mold pressure may be monitored, and the temperature may be adjusted within an acceptable range so as to achieve a desired pressure. The part is then subsequently de-molded and cured again at a temperature above the mold temperature to ensure that it is fully cured. Certain non-rubber reinforcements, such as woven fiberglass, may be included in the part so as to increase its durability, stiffness, or to alter other mechanical properties.

Any and all references specifically identified in the specification of the present application are expressly incorporated herein in their entirety by reference thereto. The term “about” and “approximately,” as used herein, should generally be understood to refer to both the corresponding number and a range of numbers. Moreover, all numerical ranges herein should be understood to include each whole integer within the range.

While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the disclosure herein.

We claim:

1. A molding system, comprising:
a mold tool operable to contain pressures generated during a molding process;
a temperature-activated pressure applicator; and
an elastomer material positioned between the mold tool and the temperature-activated pressure applicator such that as the mold tool heats up the temperature-activated pressure applicator expands forcing the elastomer material against sides of the mold.

2. The molding system of claim 1, further comprising a barrier positioned between the temperature-activated pressure applicator and the elastomer material, wherein the barrier is operable to reduce sticking to allow separation of the pressure applicator from the elastomer material after the molding process is complete.

3. The molding system of claim 2, wherein the barrier comprises a powder positioned between the elastomer material and the temperature-activated pressure applicator.

4. The molding system of claim 3, wherein the barrier further comprises two plies of low-friction material, with the powder contacting the two plies.

5. The molding system of claim 4, wherein:
a first of the plies is in contact with the temperature-activated pressure applicator; and
a second of the plies is in contact with the elastomer material.

6. The molding system of claim 3, wherein the powder is a talc powder and the two plies are a low-adhesion material.

7. The molding system of claim 4, wherein at least one of the plies is made of fluorinated ethylene propylene.

8. The molding system of claim 4, wherein both plies are made of fluorinated ethylene propylene.

9. The molding system of claim 1, wherein:
the mold tool is rigid and has first and second mold part that surround an interior cavity that receives the temperature-activated pressure applicator and the elastomer material.

10. The molding system of claim 1, wherein the temperature-activated pressure applicator is made of silicone rubber.

11. The molding system of claim 1, wherein the mold tool is a rigid, metallic tool.

12. The molding system of claim 1, wherein fibers are included with the elastomer material between the mold tool and the temperature-activated pressure applicator.

13. A method for molding an elastomer material, comprising:
providing:
a mold tool operable to contain pressures generated during a molding process,
a temperature-activated pressure applicator, and
an elastomer material;
positioning the elastomer material between the mold tool and the temperature-activated pressure applicator;
heating the pressure applicator, causing the pressure applicator to expand and force the elastomer material into the shape of the mold cavity; and
removing a molded elastomer part from the mold cavity and from the pressure applicator.

14. The method of claim 13, further comprising protruding the pressure applicator from the elastomer material so that the pressure applicator can be gripped by an operator and pulled out of the molded elastomer part during the removing of the pressure applicator.

15. The method of claim 13, further comprising providing a barrier between the elastomer material and pressure applicator, the barrier reducing sticking of the pressure applicator to the elastomer material after the molding process is complete.

16. The method of claim 15, wherein the elastomer material comprises a fluoroelastomer material.

17. The method of claim 15, wherein the barrier comprises plies of material made from a fluorinated ethylene propylene layer.

18. The method of claim 17, further comprising providing a lubricant between the plies to provide a low-friction interface between the plies.

19. The method of claim 17, wherein separating the molded elastomer part from the pressure applicator at the barrier further comprises pulling the pressure applicator causing the pressure applicator to thin down as it is being pulled, which further separates the pressure applicator from the molded elastomer part.

20. The method of claim 15, wherein the molded elastomer part is a tube.

21. The method of claim 13, wherein the mold cavity temperature of the elastomer material is kept below a temperature at which the molded elastomer part would fully cure, such that the molded elastomer part is partially cured within the mold, the method further comprising fully curing the molded elastomer part outside of the mold.

22. The method of claim 13, wherein fibers are associated with the elastomeric material to provide a material with embedded fibers.

23. A molded elastomer part comprising:
a tube formed of a fluoroelastomer material and fibers; and
a layer of material lining the inside of the tube, wherein the material comprises at least one ply of fluorinated ethylene propylene.

24. The molded elastomer part of claim 23, wherein the tube is made with a closed end.
